(19) United States
(12) Patent Application Publication
(10) Pub. No.: US 2017/0059944 A1
(43) Pub. Date: Mar. 2, 2017

(54) PIXEL ELECTRODE UNIT, DISPLAY PANEL AND LIQUID CRYSTAL DISPLAY DEVICE

(71) Applicant: SHENZHEN CHINA STAR OPTOELECTRONICS TECHNOLOGY CO., LTD., Shenzhen, Guangdong (CN)

(72) Inventor: Liang XU, Shenzhen, Guangdong (CN)

(21) Appl. No.: 14/647,099

(22) PCT Filed: May 23, 2014
(86) PCT No.: PCT/CN2014/078281

§ 371 Date: May 25, 2015

(30) Foreign Application Priority Data
Apr. 18, 2014 (CN) 201410158085.6

(51) Int. Cl. G02F 1/1343

(52) U.S. Cl. CPC G02F 1/134309; G02F 1/13439; G02F 2201/123; G02F 2201/121; G02F 2201/52; G02F 2001/134345

(57) ABSTRACT

The present invention discloses a pixel electrode unit, a display panel and a liquid crystal display device. The pixel electrode unit comprises a red sub-pixel, a green sub-pixel and a blue sub-pixel. The green sub-pixel includes a green sub-pixel main area and a green sub-pixel supplementary area. The blue sub-pixel only includes a blue sub-pixel main area. Since human eyes are sensitive to the green colour, the green sub-pixel adopts 8 domains pixel electrode unit structure, while the blue sub-pixel adopts 4 domains pixel electrode unit structure. By this way, the aperture ratio of the pixel can be improved, and the balance between the aperture ratio of the pixel and the colour shift can be achieved.

### FIELD OF THE INVENTION

The invention relates to the field of liquid crystal displaying techniques, and in particular to a pixel electrode unit, a display panel and a liquid crystal display device.

### BACKGROUND OF THE INVENTION

Currently, there are mainly three types of flat panel display devices, i.e. liquid crystal displays (LCD), plasma display panels (PDP) and organic light-emitting diode (OLED) displays. There are mainly two types of techniques for showing images on a LCD device, i.e. IPS (in plan switch) and VA (vertical alignment).

In VA (vertical alignment) techniques, as shown in FIG. 4 and FIG. 5, the liquid crystal display device comprises a first substrate 11, a second substrate 12 and negative-type liquid crystals 14 sandwiched between the first substrate 11 and the second substrate 12. The liquid crystal display device further comprises a common electrode 15 formed on the first substrate 11 and a pixel electrode 13 formed on the second substrate 12. By this way, an electric field may be formed. When the voltage of the electric field is applied on the negative-type liquid crystals 14, the negative-type liquid crystals 14 slant to a specific angle, such that the longitudinal axis of the negative-type liquid crystals 14 is perpendicular to the direction of the electric field, as shown in FIG. 5.

However, to achieve a wide viewing angle in VA (vertical alignment) techniques, the VA (vertical alignment) techniques adopts a 8 domains pixel electrode unit structure instead of 4 domains pixel electrode unit structure, such as to alleviate the colour shift of the liquid crystal display device. More metal wirings and capacities are needed in 8 domains pixel electrode unit structure, so that the aperture ratio of the pixel is reduced.

### SUMMARY OF THE INVENTION

The present invention provides a pixel electrode unit, which can achieve a balance between the aperture ratio of the pixel and the colour shift.

The present invention is realized in such a way that: A pixel electrode unit, wherein the pixel electrode unit comprises a red sub-pixel, a green sub-pixel and a blue sub-pixel, the green sub-pixel includes a green sub-pixel main area and a green sub-pixel supplementary area, the blue sub-pixel only includes a blue sub-pixel main area.

Preferably, the red sub-pixel includes a red sub-pixel main area and a red sub-pixel supplementary area.

Preferably, the red sub-pixel only includes a red sub-pixel main area.

Preferably, the green sub-pixel supplementary area of the green sub-pixel is bigger than the green sub-pixel main area of the green sub-pixel.

Preferably, the pixel electrode unit further comprises a yellow sub-pixel, the yellow sub-pixel only includes a yellow sub-pixel main area.

Preferably, the pixel electrode unit further comprises a white sub-pixel, the white sub-pixel only includes a white sub-pixel main area.

According to another aspect of the present invention, there is provided a display panel, the display panel comprising a first substrate, a second substrate and negative-type liquid crystals sandwiched between the first substrate and the second substrate, the display panel further comprising a common electrode formed on the first substrate and a pixel electrode formed on the second substrate, wherein the pixel electrode includes an array of pixel electrode units, the pixel electrode unit comprises a red sub-pixel, a green sub-pixel and a blue sub-pixel, the green sub-pixel includes a green sub-pixel main area and a green sub-pixel supplementary area, the blue sub-pixel only includes a blue sub-pixel main area.

Preferably, the red sub-pixel includes a red sub-pixel main area and a red sub-pixel supplementary area.

Preferably, the red sub-pixel only includes a red sub-pixel main area.

Preferably, the green sub-pixel supplementary area of the green sub-pixel is bigger than the green sub-pixel main area of the green sub-pixel.

Preferably, the pixel electrode unit further comprises a yellow sub-pixel, the yellow sub-pixel only includes a yellow sub-pixel main area.

Preferably, the pixel electrode unit further comprises a white sub-pixel, the white sub-pixel only includes a white sub-pixel main area.

According to yet another aspect of the present invention, there is provided a liquid crystal display device, the liquid crystal display device comprises the above-mentioned display panel.

According to the present invention, the pixel electrode unit comprises a red sub-pixel, a green sub-pixel and a blue sub-pixel, the green sub-pixel includes a green sub-pixel main area and a green sub-pixel supplementary area, the blue sub-pixel only includes a blue sub-pixel main area. Since human eyes are sensitive to the green colour, the green sub-pixel adopts 8 domains pixel electrode unit structure, while the blue sub-pixel adopts 4 domains pixel electrode unit structure. By this way, the aperture ratio of the pixel can be improved, and the balance between the aperture ratio of the pixel and the colour shift can be achieved.

For more clearly and easily understanding above content of the present invention, the following text will take a preferred embodiment of the present invention with reference to the accompanying drawings for detail description as follows.

### BRIEF DESCRIPTION OF THE DRAWINGS

The drawings described herein are for illustration purposes only and are not intended to limit the scope of the present disclosure in any way.

FIG. 1 is a schematic view of the pixel electrode unit according to the first embodiment of the present invention;

FIG. 2 is a schematic view of the pixel electrode unit according to the second embodiment of the present invention;

FIG. 3 is a schematic view showing the arrangement of the pixel electrode unit according to some embodiments of the present invention;

FIG. 4 is a schematic view showing the off-state of the pixel electrode unit in VA (vertical alignment) techniques;

FIG. 5 is a schematic view showing the on-state of the pixel electrode unit in VA (vertical alignment) techniques;

FIG. 6 is a schematic view showing the structure of the pixel electrode unit in FIG. 1;

FIG. 7 is a schematic view of the pixel electrode unit according to the third embodiment of the present invention; and

FIG. 8 is a schematic view of a comparative pixel electrode unit.

### DETAILED DESCRIPTION OF THE PREFERRED EMBODIMENTS

The embodiments of the present invention will be described in detail with reference to the accompanying drawings.

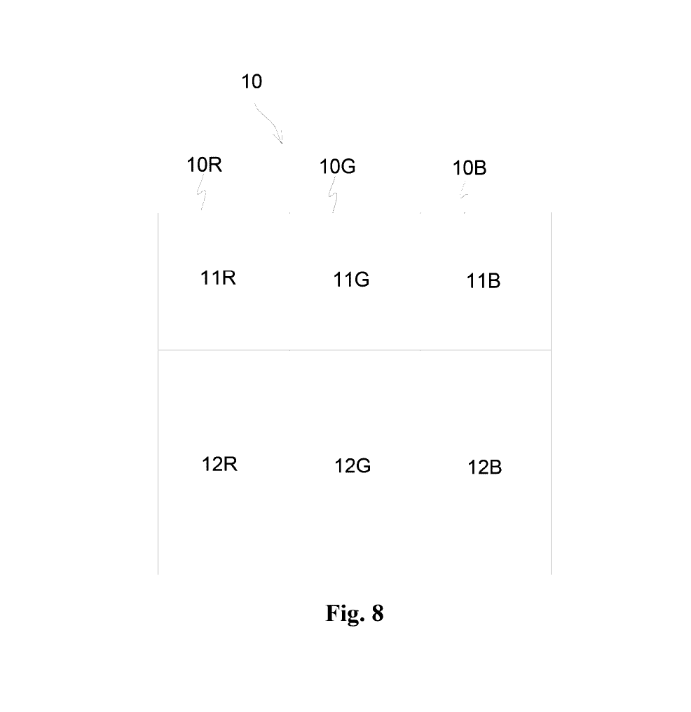

As shown in FIG. 8, the comparative pixel electrode unit 10 comprises a red sub-pixel 10R, a green sub-pixel 10G and a blue sub-pixel 10B. The green sub-pixel 10G includes a green sub-pixel main area 11G and a green sub-pixel supplementary area 12G. The red sub-pixel 10R includes a red sub-pixel main area 11R and a red sub-pixel supplementary area 12R. The blue sub-pixel 10B includes a blue sub-pixel main area 11B and a blue sub-pixel supplementary area 12B. The red sub-pixel 10R, the green sub-pixel 10G and the blue sub-pixel 10B adopt 8 domains pixel electrode unit structure, such as to reduce the colour shift. However, more metal wirings and capacities are needed in 8 domains pixel electrode unit structure, so that the aperture ratio of the pixel is reduced.

In the present invention, different colour sub-pixels adopt different multi-domains pixel electrode unit structure according to the wavelength of the colour. Since human eyes are sensitive to the light with about 550 nm wavelength, the green sub-pixel adopts 8 domains pixel electrode unit structure, while the blue sub-pixel adopts 4 domains pixel electrode unit structure. By this way, the aperture ratio of the pixel can be improved, and the balance between the aperture ratio of the pixel and the colour shift can be achieved.

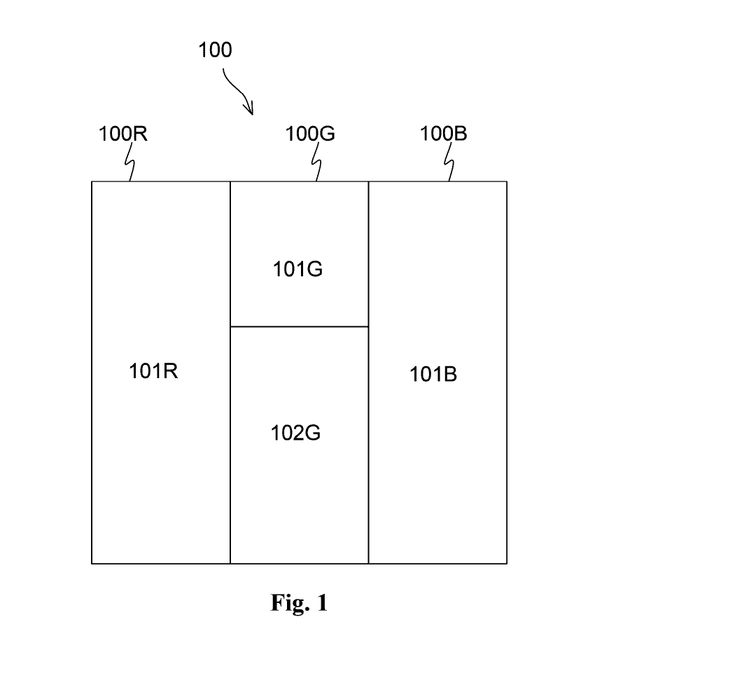

In the first embodiment, as shown in FIG. 1, the pixel electrode unit 100 comprises a red sub-pixel 100R, a green sub-pixel 100G and a blue sub-pixel 100B. The green sub-pixel 100G includes a green sub-pixel main area 101G and a green sub-pixel supplementary area 102G. The blue sub-pixel 100B only includes a blue sub-pixel main area 101B. The red sub-pixel 100R only includes a red sub-pixel main area 101R.

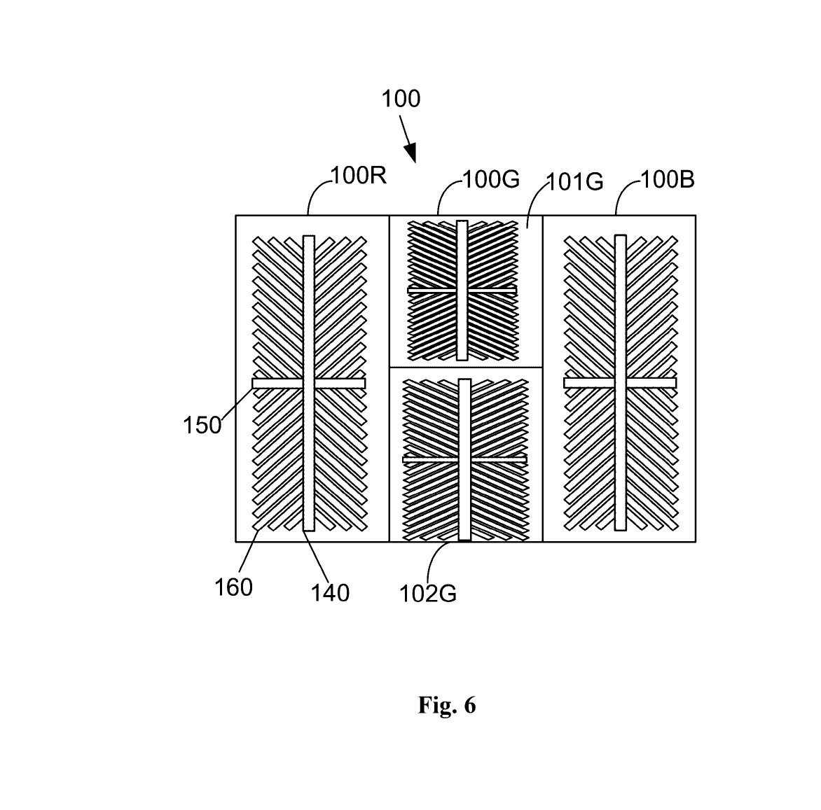

The green sub-pixel supplementary area 102G of the green sub-pixel 100G is bigger than the green sub-pixel main area 101G of the green sub-pixel 100G. As shown in FIG. 6, the green sub-pixel supplementary area 102G, the green sub-pixel main area 101G, the red sub-pixel main area 101R and the blue sub-pixel main area 101B are asterisk-like patterns. The red sub-pixel main area 101R will be used as an example for further description. The red sub-pixel main area 101R includes a first backbone portion 140, a second backbone portion 150 and a plurality of spine portions 160. The first backbone portion 140 is perpendicular to the second backbone portion 150, such that the red sub-pixel main area 101R is divided into 4 areas (4 domains). The plurality of spine portions 160 extends from the first backbone portion 140 and the second backbone portion 150 in a tilt way relative to the first backbone portion 140 and the second backbone portion 150. The plurality of spine portions 160 extends in a parallel way relative to each other.

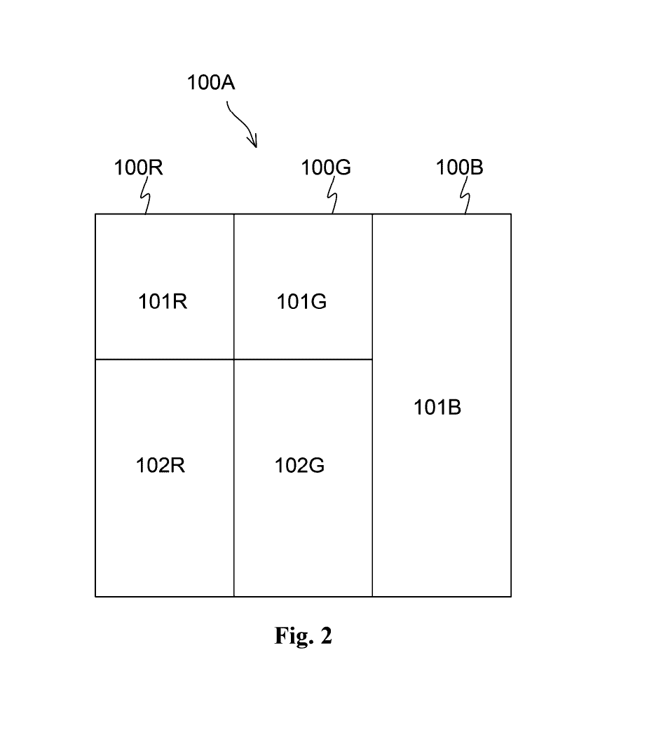

In the second embodiment, as shown in FIG. 2, the pixel electrode unit 100A comprises a red sub-pixel 100R, a green sub-pixel 100G and a blue sub-pixel 100B. The green sub-pixel 100G includes a green sub-pixel main area 101G and a green sub-pixel supplementary area 102G. The blue sub-pixel 100B only includes a blue sub-pixel main area 101B. The red sub-pixel 100R includes a red sub-pixel main area 101R and a red sub-pixel supplementary area 102R. Human eyes are also sensitive to the red colour, the red sub-pixel adopts 8 domains pixel electrode unit structure, such as to reduce the colour shift.

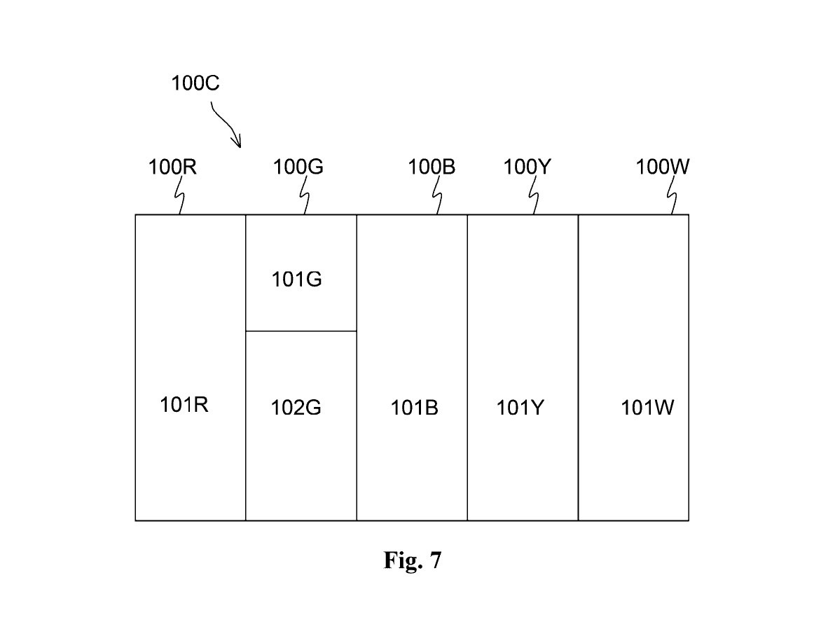

In the third embodiment, as shown in FIG. 7, the pixel electrode unit 100C comprises a red sub-pixel 100R, a green sub-pixel 100G, a blue sub-pixel 100B, a yellow sub-pixel 100Y and a white sub-pixel 100W. The green sub-pixel 100G includes a green sub-pixel main area 101G and a green sub-pixel supplementary area 102G. The blue sub-pixel 100B only includes a blue sub-pixel main area 101B. The red sub-pixel 100R only includes a red sub-pixel main area 101R. The yellow sub-pixel 100Y only includes a yellow sub-pixel main area 101Y. The white sub-pixel 100W only includes a white sub-pixel main area 101W.

According to another aspect of the present invention, a display panel 1000 is provided. The display panel 1000 comprises a first substrate 11, a second substrate 12 and negative-type liquid crystals 14 sandwiched between the first substrate 11 and the second substrate 12. The display panel 1000 further comprises a common electrode 15 formed on the first substrate 11 and a pixel electrode 13 formed on the second substrate 12. The common electrode 15 and the pixel electrode 13 are formed of transparent conductive materials, such as ITO (Indium tin oxide), IZO (indium-doped zinc oxide).

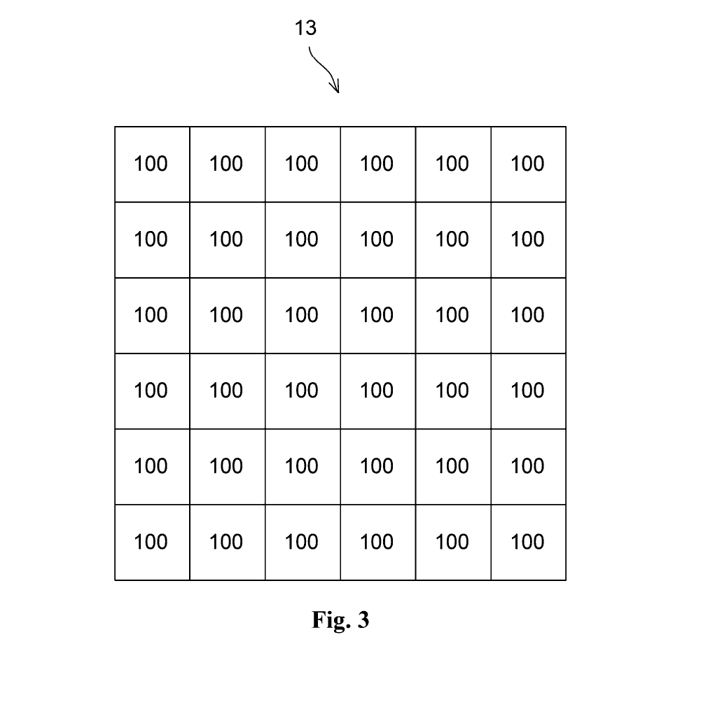

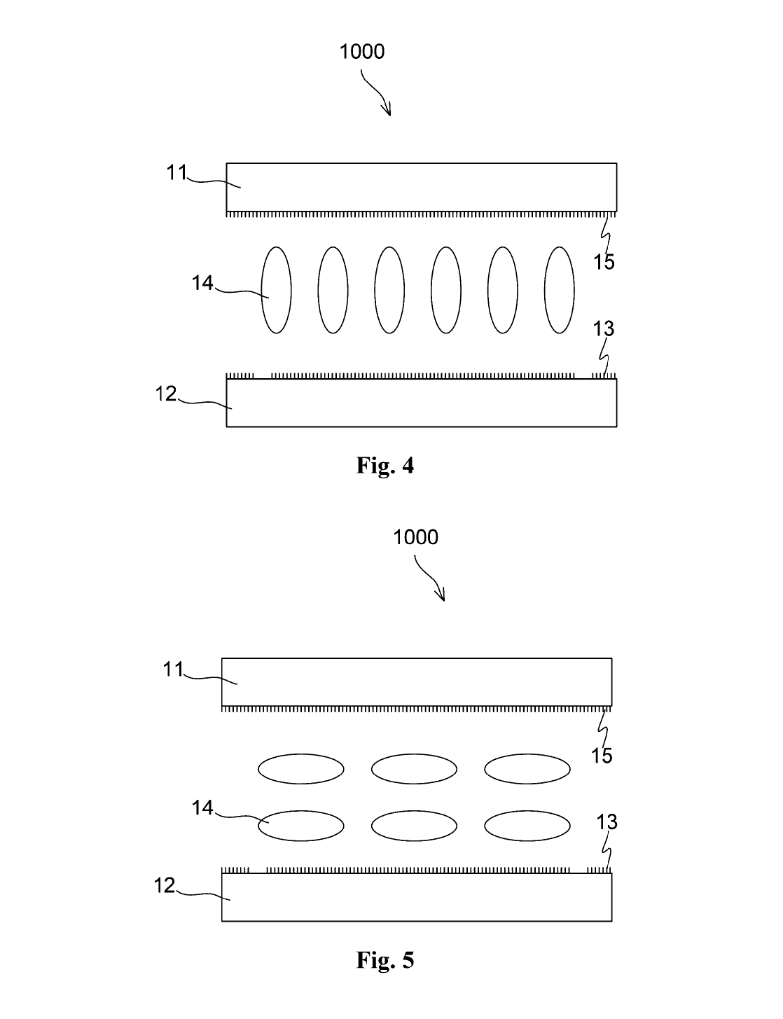

The pixel electrode 13 includes an array of pixel electrode units. As shown in FIG. 3, the pixel electrode unit may be the pixel electrode unit 100, the pixel electrode unit 100A or the pixel electrode unit 100C for example.

According to yet another aspect of the present invention, a liquid crystal display device is provided. The liquid crystal display device comprises the above-mentioned display panel.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A pixel electrode unit, comprising a red sub-pixel, a green sub-pixel and a blue sub-pixel, the green sub-pixel including a green sub-pixel main area and a green sub-pixel supplementary area, the blue sub-pixel only including a blue sub-pixel main area.

2. The pixel electrode unit of claim 1, wherein the red sub-pixel includes a red sub-pixel main area and a red sub-pixel supplementary area.

3. The pixel electrode unit of claim 1, wherein the red sub-pixel only includes a red sub-pixel main area.

4. The pixel electrode unit of claim 1, wherein the green sub-pixel supplementary area of the green sub-pixel is bigger than the green sub-pixel main area of the green sub-pixel.

5. The pixel electrode unit of claim 1, wherein the pixel electrode unit further comprises a yellow sub-pixel, the yellow sub-pixel only includes a yellow sub-pixel main area.

6. The pixel electrode unit of claim 1, wherein the pixel electrode unit further comprises a white sub-pixel, the white sub-pixel only includes a white sub-pixel main area.

7. A display panel, comprising a first substrate, a second substrate and negative-type liquid crystals sandwiched between the first substrate and the second substrate, the display panel further comprising a common electrode formed on the first substrate and a pixel electrode formed on the second substrate, wherein the pixel electrode includes an array of pixel electrode units, the pixel electrode unit comprises a red sub-pixel, a green sub-pixel and a blue sub-pixel, the green sub-pixel includes a green sub-pixel main area and a green sub-pixel supplementary area, the blue sub-pixel only includes a blue sub-pixel main area.

8. The display panel of claim 7, wherein the red sub-pixel includes a red sub-pixel main area and a red sub-pixel supplementary area.

9. The display panel of claim 7, wherein the red sub-pixel only includes a red sub-pixel main area.

10. The display panel of claim 7, wherein the green sub-pixel supplementary area of the green sub-pixel is bigger than the green sub-pixel main area of the green sub-pixel.

11. The display panel of claim 7, wherein the pixel electrode unit further comprises a yellow sub-pixel, the yellow sub-pixel only includes a yellow sub-pixel main area.

12. The display panel of claim 7, wherein the pixel electrode unit further comprises a white sub-pixel, the white sub-pixel only includes a white sub-pixel main area.

13. A liquid crystal display device, comprising an display panel, the display panel comprising a first substrate, a second substrate and negative-type liquid crystals sandwiched between the first substrate and the second substrate, the display panel further comprising a common electrode formed on the first substrate and a pixel electrode formed on the second substrate, wherein the pixel electrode includes an array of pixel electrode units, the pixel electrode unit comprises a red sub-pixel, a green sub-pixel and a blue sub-pixel, the green sub-pixel includes a green sub-pixel main area and a green sub-pixel supplementary area, the blue sub-pixel only includes a blue sub-pixel main area.

14. The liquid crystal display device of claim 13, wherein the red sub-pixel includes a red sub-pixel main area and a red sub-pixel supplementary area.

15. The liquid crystal display device of claim 13, wherein the red sub-pixel only includes a red sub-pixel main area.

16. The liquid crystal display device of claim 13, wherein the green sub-pixel supplementary area of the green sub-pixel is bigger than the green sub-pixel main area of the green sub-pixel.

17. The liquid crystal display device of claim 13, wherein the pixel electrode unit further comprises a yellow sub-pixel, the yellow sub-pixel only includes a yellow sub-pixel main area.

18. The liquid crystal display device of claim 13, wherein the pixel electrode unit further comprises a white sub-pixel, the white sub-pixel only includes a white sub-pixel main area.
